(19) United States
(12) Patent Application Publication
(10) Pub. No.: US 2002/0165768 A1
(43) Pub. Date: Nov. 7, 2002

(54) Advertisement information processing system

(76) Inventors: Tatsuya Haraguchi, Yokohama-shi (JP); Kazuhiro Ogura, Kawasaki-shi (JP)

Correspondence Address: Johnny A. Kumar, FOLEY & LARDNER, Washington Harbour, 3000 K Street, N.W., Suite 500, Washington, DC, 20007-5109, US

(21) Appl. No.: 09/846,023

(22) Filed: May 1, 2001

(51) Int. Cl. G06F 17/60

(52) U.S. Cl. 705/14

(57) ABSTRACT

When a customer has depressed a print button associated with a display section displaying display information serving as advertisement information desired by the customer, a controller determines whether the advertisement information displayed on the display section had been changed immediately before the print button was depressed. If the advertisement information had not been changed, a commodity corresponding to the advertisement information is discriminated. The controller confirms whether the advertisement information can be printed out, by referring to a commodity information database with respect to the commodity for which the discriminated advertisement information is to be printed. If there is no problem with the provision or advertisement of the commodity information, the controller acquires print data by referring to an advertisement information database, and instructs a printer to print out the print data via an input/output control section.

### BACKGROUND OF THE INVENTION

The present invention relates to an advertisement information processing system for processing advertisement information relating to customer-participation-type or event-performance-type plan goods, such as travel plans and event plans.

A great number of package tour pamphlets for providing information to customers have conventionally been displayed in front of, or within, offices of travel agencies or package tour agencies. In order to meet modern customer needs, the number of kinds of package tours tends to increase, while the amount of each kind of tours tends to decrease. In addition, the effective terms for providing package tours become short and various. Thus, the amount and the number of kinds of pamphlets to be managed in each office are very large, and each office bears a great work load for managing and changing displayed pamphlets.

In order to solve the problem, there is an idea that pamphlets are managed as electronic data so that customers may inspect and print out it on an as-needed basis.

For example, Jpn. Pat. Appln. KOKAI Publication No. 11-306204 discloses a pamphlet preparation system for retrieving travel information and outputting travel pamphlets. In this system, necessary information may be selected and pamphlets with such information may be prepared and output. According to this pamphlet preparation system, only necessary information for each customer is selected and a customer-specific pamphlet is prepared and printed out. In addition, it is possible to carry out a booking process in parallel with the pamphlet preparing/outputting process.

Similarly, Jpn. Pat. Appln. KOKAI Publication No. 10-207905 discloses a goods information search system in which goods information in a host computer is requested from a retrieval terminal and is output. This goods information search system is designed to decrease a time period between the issuance of the request from the terminal device and the output of the information.

The effect of appeal to customers is great with the currently prevalent display system in offices, wherein a great number of paper pamphlets are displayed using wall surfaces or shelves. Thus, an advertisement effect proportional to display areas, such as a demand-inducing effect, may be expected of passersby in front of offices. In addition, a plurality of customers can access advertisement information at a time, and can easily take it home. The large-scale display system has such various effects.

On the other hand, in the electronic pamphlet system devised to solve the present problem, travel pamphlets are managed as electronic data and customers inspect and print out the data on an as-needed basis. Thereby, in fact, the work load of each office for managing pamphlets is decreased, and saving of paper resources is expectable.

However, unless special devices are made in the advertisement information display method, the advantages of the conventional advertisement method, such as the effect of appeal to customers and the access by plural customers, cannot be realized. It is thus difficult to completely displace the conventional advertisement method.

### BRIEF SUMMARY OF THE INVENTION

An object of the present invention is to provide an advertisement information processing system, which has an advertisement information display section capable of simultaneously displaying plural information items of plan goods on a display region, and which can realize the same advertisement appeal effect to customers as the conventional advertisement system.

Another object of the invention is to provide an advertisement information processing system, which includes input devices associated with plural display regions for simultaneously displaying advertisement information of plan goods, and which can realize the same access by plural customers as the conventional advertisement method by printing out information relating to display contents of the associated display regions.

Still another object of the invention is to provide an advertisement information processing system, which analyzes a print request history associated with advertisement information on each item of plan goods, thereby determining the degree of attention of customers to each of plan goods and enhancing the advertisement effect.

Still another object of the invention is to provide an advertisement information processing system, which can easily change the prices of plan goods and produce new plan goods according to customers' requests, thereby enhancing the quality of services and providing satisfactory plan goods.

In order to achieve the objects, the present invention provides an advertisement information processing system for processing advertisement information relating to various commodities, comprising: storage means for storing, in a mutually associated manner, display information and print information on the advertisement information relating to various commodities; advertisement display means, composed of a plurality of display means, for displaying the display information stored in the storage means; display control means for effecting a control to display one or more display information items stored in the storage means on the plurality of display means constituting the advertisement display means; a plurality of instruction means, provided in association with the plural display means constituting the advertisement display means, for individually instructing printing of the display information displayed on the display means; print control means for effecting, when printing is instructed by any one of the plural instruction means, a control to read out the print information and print out the print information, which corresponds to the display information displayed on the display means associated with the instruction means; and print means for printing the print information controlled by the print control means.

The invention provides an advertisement information processing system for processing commodity information and advertisement information relating to plan commodities planned in advance, comprising: storage means for storing commodity information relating to the plan commodities, and display information and print information serving as advertisement information relating to the plan commodities; advertisement display means, composed of a plurality of display means, for displaying the display information serving as the advertisement information; price control means for effecting a control to vary the price of the plan commodity in accordance with a variation in the commodity information stored in the storage means; and display control means for effecting a control to display price information controlled by the price control means and the display information that is stored in the storage means and serves as the advertisement information on the plan commodity on one or more of the display means constituting the advertisement display means.

The invention provides an advertisement information processing system for processing commodity information and advertisement information relating to plan commodities planned in advance, comprising: acceptance means for accepting customer applications for the plan commodity-and customers' proposed upper limit prices; storage means for storing application information and proposed upper limit price information relating the plan commodity accepted by the acceptance means; and determination means for determining whether the plan commodity is feasible or not, on the basis of the application information and proposed upper limit price information stored in the storage means.

The invention provides an advertisement information processing system for processing commodity information and advertisement information relating to commodities, comprising: acceptance means for accepting a customer's request for the commodity; generating means for generating a plan commodity according the request accepted by the acceptance means; storage means for storing commodity information relating to the plan commodity generated by the generating means, and display information and print information serving as advertisement information relating to the plan commodity; advertisement display means, composed of a plurality of display means, for displaying the display information serving as the advertisement information; and control means for effecting a control to display the display information serving as the advertisement information relating to the plan commodity on the advertisement display means on the basis of the commodity information relating to the plan commodity that is stored in the storage-means.

### BRIEF DESCRIPTION OF THE SEVERAL VIEWS OF THE DRAWING

FIG. 1A shows an external structure of a plan commodity management system according to an advertisement information processing system of the present invention;

FIG. 1B is an enlarged view of a portion of a wall display, which comprises a display section and a print button;

FIG. 2 is a block diagram showing a module structure of the plan commodity management system;

FIG. 3 shows an example of a structure of commodity information stored in a commodity information database;

FIG. 4 shows an example of a structure of price information stored in a price information database;

FIG. 5 shows an example of a structure of advertisement information stored in an advertisement information database;

FIG. 6 shows an example of a structure of an advertisement history stored in an advertisement history database;

FIG. 7 shows an example of a structure of a commodity application stored in a commodity application database;

FIG. 8 shows internal structural components of data stored in commodity generation information database;

FIG. 9 is a flow chart illustrating an advertisement information printing operation in the plan commodity management system;

FIG. 10 is a flow chart illustrating a plan commodity price changing process in the plan commodity management system;

FIG. 11 is a flow chart illustrating a plan commodity price changing process in accordance with the number of customer applications and a minimum necessary number of persons for a plan commodity;

FIG. 12 is a flow chart illustrating a plan commodity price changing process in accordance with the number of customer applications and the number of days up to the deadline for applications;

FIG. 13 is a flow chart illustrating an operation in a case where an application for a plan commodity has been received; and

FIG. 14 shows an example of varied prices.

### DETAILED DESCRIPTION OF THE INVENTION

Embodiments of the present invention will now be described with reference to the accompanying drawings.

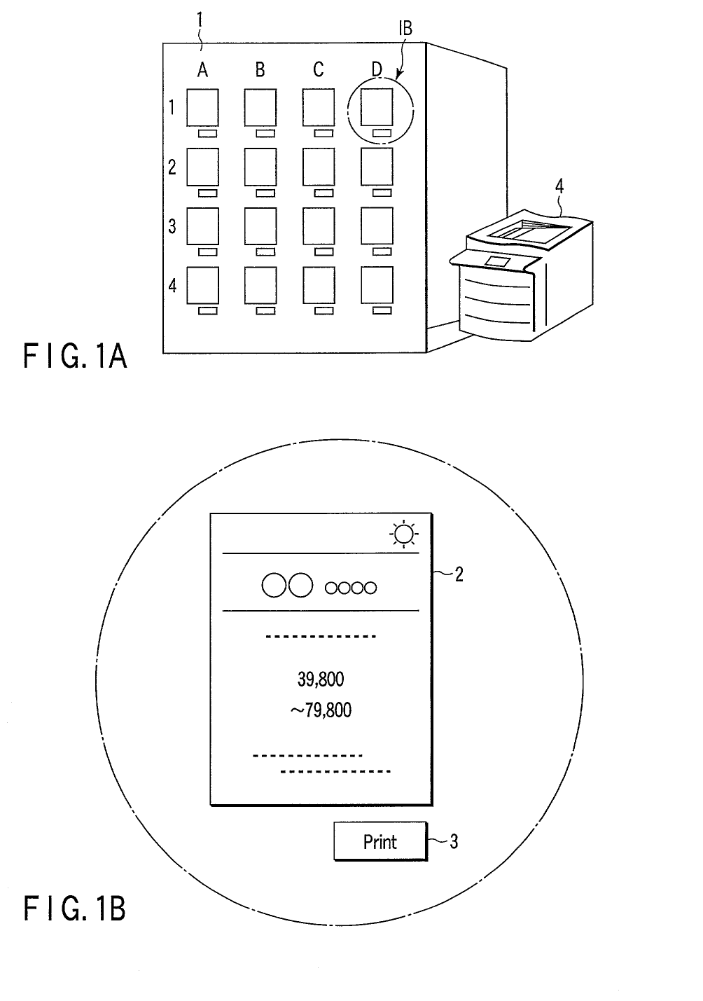

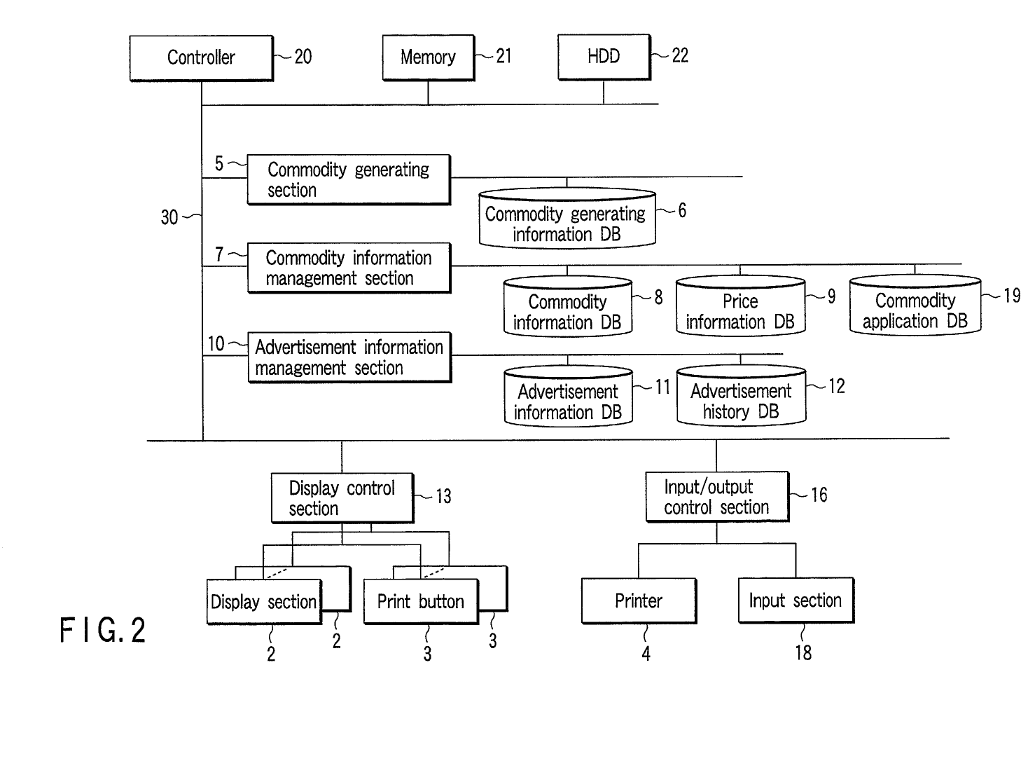

FIG. 1A shows an external structure of a plan commodity management system according to an advertisement information processing system of the present invention. The plan commodity management system comprises a wall display 1 and a printer 4. The wall display 1 is substituted for a conventional wall shelf that displays a great number of paper pamphlets in offices. The wall display 1 displays different advertisement information items on a plurality of divided display sections. The printer 4 prints out a pamphlet for which a print request has been issued.

The wall display 1 comprises display sections 2 and print buttons 3. The display sections 2 are composed of liquid crystal displays or CRT displays for displaying advertisement information corresponding to covers of pamphlets. The display sections 2 are arranged in a plurality of rows and columns. The print buttons 3 are provided in association with the corresponding display sections 2. The print buttons 3 are depressed to designate printing of advertisement information displayed on the display sections 3.

The positions (in columns) of the display sections 2 are indicated by marks A, B, C and D from the left in the Figure and the positions (in rows) are indicated by 1, 2, 3 and 4 from above in the Figure. For example, the display section 2 at position A4 is located at a lower left part in the Figure, and the display section 2 at position D1 is located at an upper right part in the Figure.

FIG. 1B is an enlarged view of a portion of the wall display 1, which comprises the display section 2 and print button 3. When the print button 3 is depressed, as shown in FIG. 1B, advertisement information displayed on the associated display section 2 is printed out from the printer 4 as a paper pamphlet.

FIG. 2 schematically shows the structure of a control system of the plan commodity management system. The control system of the plan commodity management system comprises a controller 20 for controlling the entirety of the system; a memory 21 for storing various information; a hard disk drive (HDD) 22 for storing various data; a commodity generating section 5 for automatically generating plan commodities; a commodity information management section 7 for managing information relating to plan commodities; an advertise information management section 10 for managing advertisement information relating to plan commodities; a display control section 13 for effecting a control relating to display of advertisement information; and an input/output control section 16 for effecting a control relating to output of paper pamphlets. These structural components are connected over a bus 30. Necessary data is transmitted/received among the structural components over the bus 30.

The controller 20 comprises a CPU, etc. The controller 20 controls the operation of the entirety of the plan commodity management system. The controller 20 operates according to prestored control programs and control data.

The memory 21 comprises a ROM for storing control programs and control data, an NVM for storing variable set values, and a RAM for temporarily storing information. The memory 21 is used for temporarily storing various information or part of data when the controller 20 is activated.

The HDD 22 stores various data. The HDD 22 stores various data for operating the plan commodity management system or user-specific set information.

The commodity generating section 5 is a module for automatically generating plan commodities. The commodity generating section 5 is connected to a commodity generating information database (DB) 6 for storing necessary information for generating new plan commodities.

The commodity information management section 7 is a module for managing information relating to plan commodities. The commodity information management section 7 is connected to a commodity information database (DB) 8 for storing basic commodity information and customer information relating to commodities (the number of applications, the number of contracts, etc.); a price information database (DB) 9 for storing price information to be used when a variable price system is applied; and a commodity application database (DB) 19 for storing customer application information to be used when a customer-designated price system is applied.

The advertisement information management section 10 is a module for managing advertisement information relating to plan commodities. The advertisement information management section 10 is connected to an advertisement information database (DB) 11 for storing advertisement information such as electronically produced pamphlet data, and to an advertisement history database (DB) 12 for storing history information relating to display of advertisement information and customer's print requests for advertisement.

The display control section 13 is a module for effecting a control relating to display of advertisement information on plan commodities. The display control section 13 is connected to the display sections 2 for displaying advertisement information and the print buttons 3 for inputting print requests for advertisement information displayed on the display sections 2.

The input/output control section 16 is a module for effecting a control relating to output of paper pamphlets. The input/output control section 16 is connected to the printer 4 for printing out paper pamphlets, and an input section 18 for designating search conditions at the time of searching for plan commodity information to be output.

Examples of structures of the respective databases will now be described.

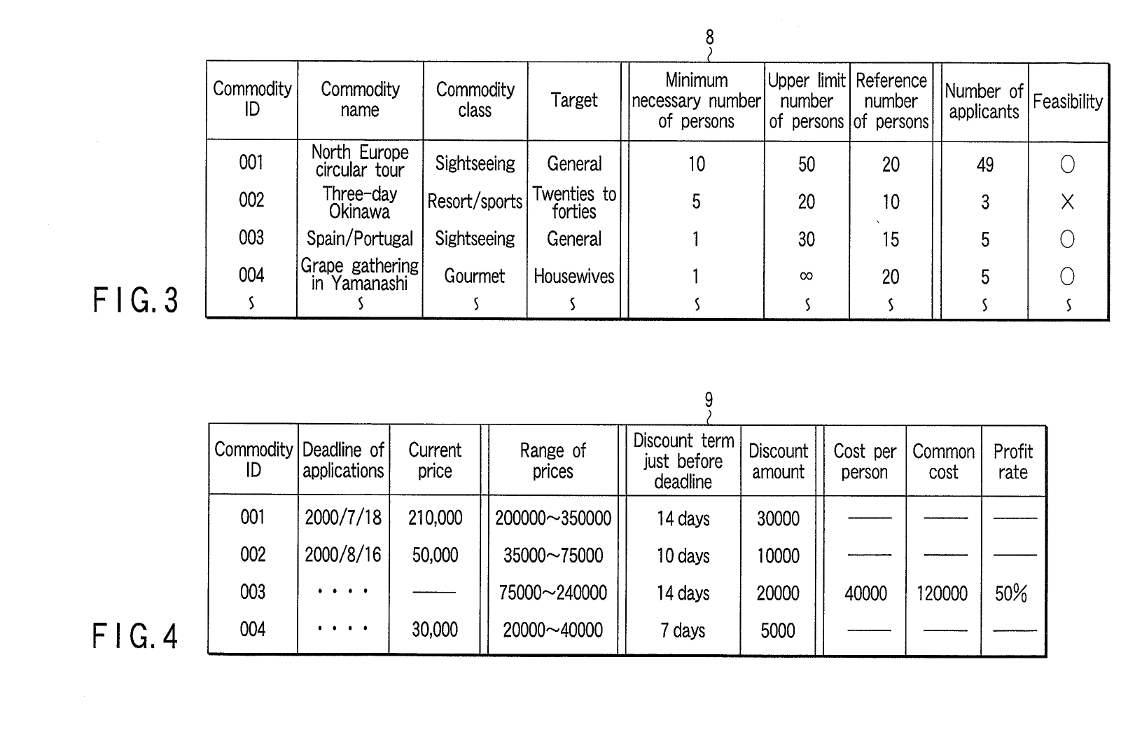

FIG. 3 shows an example of the structure of commodity information stored in the commodity information DB 8. The commodity information DB 8 stores basic commodity information and customer information relating to commodities (the number of applications, the number of contracts, etc.). In association with a commodity ID assigned to each package tour commodity, the following commodity information items are stored: commodity name; commodity class; target (customers for which commodities are produced); minimum necessary number of persons; upper limit number of persons; reference number of persons who are assumed to participate; number of applicants for commodities at present; and feasibility at present. The minimum necessary number of persons, the upper limit number of persons and the reference number of persons constitute commodity attribute information. The number of applications and the feasibility constitute information indicative of the present state.

For example, as regards the commodity ID “001”, the following information items are stored: the commodity name “North Europe circular tour”; the commodity class “Sightseeing”; the target “General”; the minimum necessary number of persons “10”; the upper limit number of persons “50”; the reference number of persons “20”; the number of applicants “49”; and the feasibility “◯”.

FIG. 4 shows an example of the structure of price information stored in the price information DB 9. The price information DB 9 stores price information to be used when a variable price system is applied. In association with the commodity ID assigned to each package tour commodity, the following price information items are stored: deadline date of applications for commodities; current price of commodity set at present; range of permissible prices of commodities; discount term just before deadline date, when discount is made just before the deadline date for commodity application; discount amount; cost per person; common cost for performing plan commodities; and profit rate. The discount term just before deadline date and the discount amount constitute commodity price information. The cost per person, common cost, and profit rate constitute internal attribute information to be used when an auction-type commodity sales method is applied.

For example, as regards the commodity ID “001”, the following information items are stored: the deadline date of applications “Jul. 18, 2000”; the current price “210,000”; the range of prices “200000 to 350000”; the discount term just before deadline date “14 days”; and the discount amount “30000”.

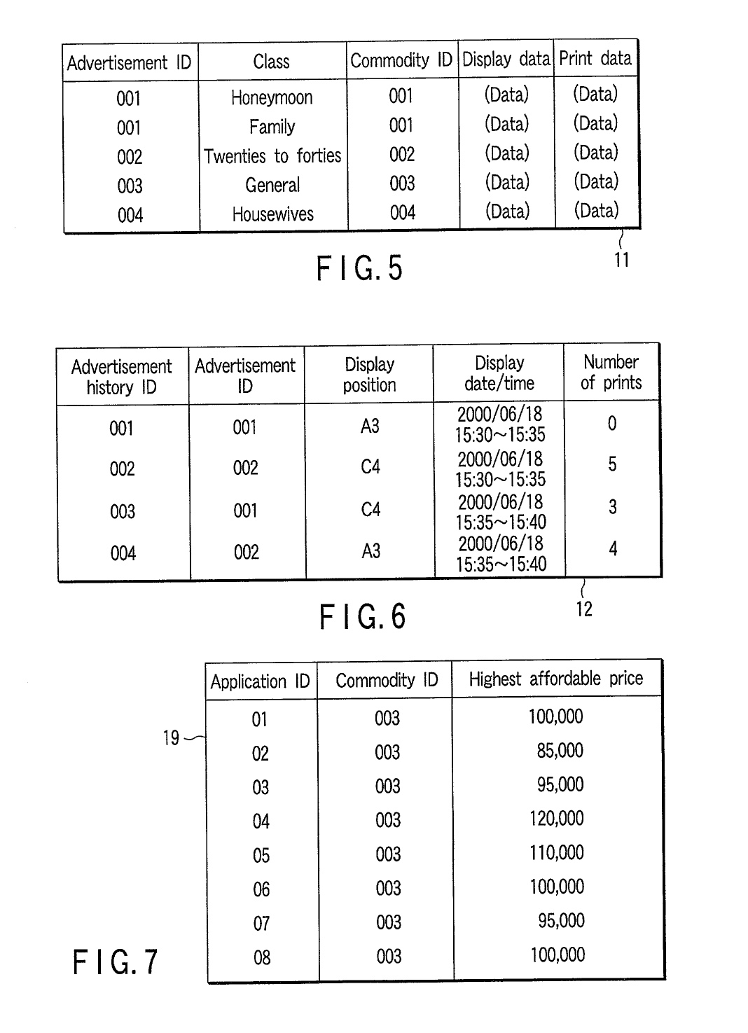

FIG. 5 shows an example of the structure of advertisement information stored in the advertisement information DB 11. The advertisement information DB 11 stores advertisement information such as electronically produced pamphlet data. In association with an advertisement ID assigned to each package tour commodity, the following advertisement information items are stored: class of target customers of advertisement information; commodity ID of associated commodity; display data of advertisement information; and print data of advertisement information.

For example, as regards the advertisement ID “001”, the following information items are stored: the class “Honeymoon”; the commodity ID “001”; the display data “(data)”; and the print data “(data)”.

FIG. 6 shows an example of the structure of the advertisement history stored in the advertisement history DB 12. The advertisement history DB 12 stores history information relating to display of advertisement information and customer's print requests for advertisement. In association with an advertisement history ID, the following advertisement history information items are stored: corresponding advertisement ID; display position of display section 2 displaying corresponding advertisement information; display date/time of display of corresponding advertisement information; and number of prints of corresponding advertisement.

For example, as regards the advertisement history ID “001”, the following information items are stored: the advertisement ID “001”; the display position “A3”; the display date/time “Jun. 18, 2000”; the number of prints “0”.

The display position is specified by the column (A to D) of the display section 2 in FIG. 1A and the row (1 to 4) as counted from above. The position “A3” indicates the display section 2 in column A and row 3 in FIG. 1A, and the position “C4” indicates the display section 2 in column C and row 4 in FIG. 1A.

FIG. 7 shows an example of the structure of commodity application stored in the commodity application DB 19. The commodity application DB 19 stores customer application information to be used when a customer-designated price system is applied. In association with an application ID, the following commodity application information items are stored: commodity ID of an object of application; and highest affordable price designated by customer.

For example, as regards the application ID “01”, the following information items are stored: the commodity ID “003” and the highest affordable price “100,000”.

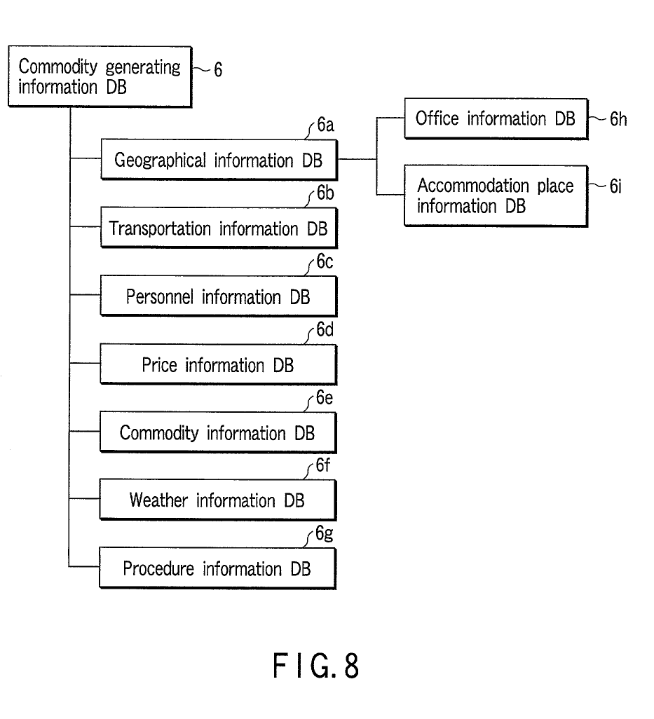

In this description, the data structure of the information necessary for generating new plan commodities, which is stored in the commodity generating information DB 6, is not exemplified. However, as is shown in FIG. 8, the commodity generating information DB 6 comprises the following internal constituent data elements: a geographical information database (DB) 6a consisting of event geographical information of plan commodities; a transportation information database (DB) 6b consisting of transportation information of plan commodities; a personnel information database (DB) 6c consisting of personnel information relating to plan commodities; a price information database (DB) 6d consisting of prices of plan commodities; a commodity information database (DB) 6e consisting of commodity information of plan commodities; a weather information database (DB) 6f consisting of weather information on the places of performance of events of plan commodities; and a procedure information database (DB) 6g consisting of procedure information on plan commodities. The geographical information DB 6a comprises an office information database (DB) 6h and an accommodation place information database (DB) 6i relating to plan commodities.

The plan commodity management system of the present invention provides a novel advertisement means for selling plan commodities such as package tour goods.

The range of the plan commodities, to which the present invention is applicable, covers commodities in modes associated with participation and movement of customers, such as package tour goods as well as various event goods including concerts, plays, sports and exhibitions, and transportation tickets of trains, airlines, etc.

Besides, the present invention is applicable to systems for distributing catalogues of general goods such as electrical products, and shop display systems for displaying information varying over time, such as real estate information and used-car information.

The present invention can be embodied in real shops as well as virtual shops on the Internet.

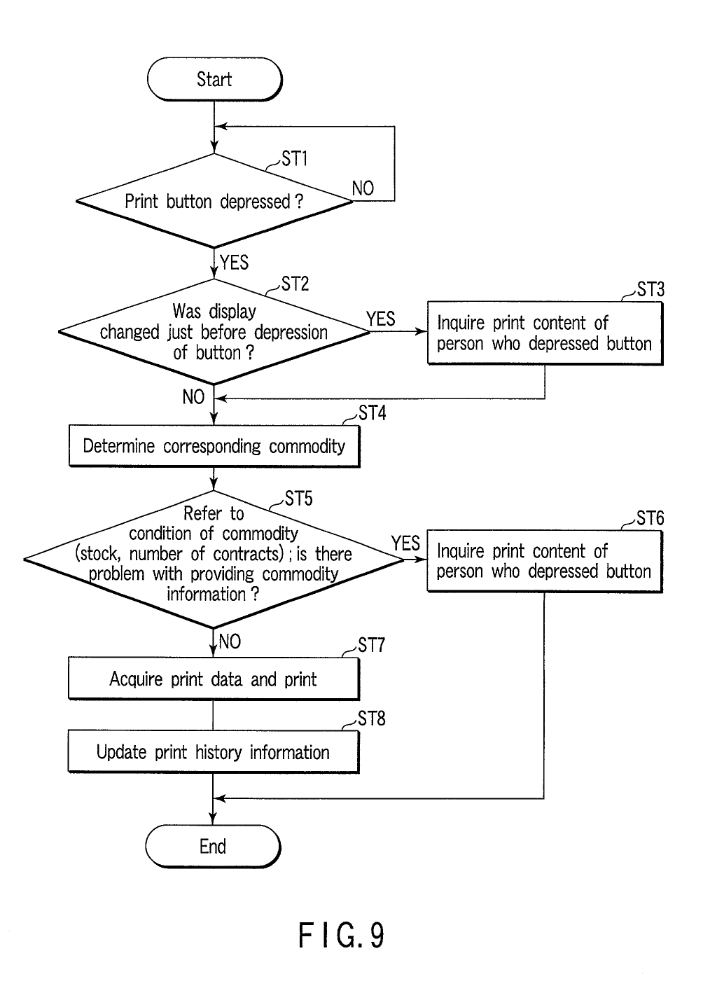

Referring to a flow chart of FIG. 9, a description will now be given of an advertisement information printing operation in the plan commodity management system having the above structure.

The controller 20 controls the advertisement information management section 10 to read out, in the order of advertisement IDs, the corresponding display data (cover of travel pamphlet), class and commodity ID from the advertisement information DB 11, and outputs the read-out data to the display control section 13. The display control section 13 distributes the supplied display data to the respective display sections 2.

Based on the class data supplied along with the display data, the display control section 13 may specify the display sections 2 to which the display data is to be distributed. For example, in time slots in which housewives are main customers passing by the wall display 1, the display data with the class “housewives” is distributed to the display sections 2 located in the second row from above, i.e. a position with high emphasis effect of advertisement. Thus, the display data is displayed on the display sections 2.

The display control section 13 manages the display data displayed on the display sections 2 on the basis of the commodity IDs. In addition, the display control section 13 changes the display data on the display sections 2 at predetermined time intervals (“display change”) and also monitors the time intervals of display change.

In this state, a customer depresses the print button 3 near the display section 2 of wall display 1, which displays the advertisement desired by the customer (ST1). With the depression of the button, the display control section 13 determines whether the display data on the display section 2 had been changed immediately before the print button 3 was depressed (ST2).

If it is determined that the display data was not changed, the display control section 13 determines the commodity ID corresponding to the display data displayed on the display section 2 near the print button 3, and outputs a print instruction, commodity ID and display position data of the display section 2 to the controller 20 (ST3).

Based on the supplied commodity ID, the controller 20 instructs the advertisement information management section 10 to read out the advertisement ID from the advertisement information DB 11. An advertisement history ID is added to the read-out advertisement ID, commodity ID, display position of display section 2 and the present data/time to generate advertisement history information. The advertisement information management section 10 additionally stores the advertisement history information in the advertisement history DB 12.

In addition, the controller 20 controls the commodity information management section 7 on the basis of the supplied commodity ID and determines the condition of the commodity on the basis of the stored data in the commodity information DB 8 corresponding to the commodity ID (ST4). For example, when the upper limit number of persons has already been reached, it is determined that further applications are unacceptable.

If the controller 20 determines that further applications are acceptable (ST5), it controls the advertisement information management section 10 on the basis of the commodity ID, and reads out the print data (travel pamphlet of plural pages) corresponding to the commodity ID and the advertisement ID from the advertisement information DB 11. The read-out print data and advertisement ID are output to the input/output control section 16. The input/output control section 16 outputs the supplied print data to the printer 4. Thereby, the print data corresponding to the desired travel pamphlet is printed out by the printer 4 (ST7).

Following the completion of printing by the printer 4, the input/output control section 16 outputs print-end information and advertisement ID to the controller 20. Based on the supplied advertisement ID, the controller 20 instructs the advertisement information management section 8 to record an updated number of prints (+1) in the advertisement history DB 12 (ST8).

If it is determined in step ST2 that the display data was changed (display change), the display control section 13 displays on the display section 2 near the print button 3 a guidance screen asking whether a pamphlet corresponding to the currently displayed data or a pamphlet corresponding to the data displayed immediately before should be printed (ST3).

If an instruction is issued in response to the guidance to the effect that the pamphlet corresponding to the currently displayed data should be printed, the control advances to step ST4. Alternatively, if an instruction is issued to the effect that the pamphlet corresponding to the data displayed immediately before should be printed, this print instruction, commodity ID and display position data of the display section 2 are output to the controller 20, and the control goes to step ST4.

If it is determined in step ST5 that further applications are unacceptable, the controller 20 controls the display control section 13 to display on the display section 2 near the print button 3 a guidance message that no printing is effected since further applications are unacceptable. In short, the customer who instructed the printing is informed of the present condition (ST6).

A display process will now be described.

The plan commodity management system of the present invention has plural display sections 2 of wall display 1, as shown in FIG. 1A. Thus, the display process relating to the order of display, display positions and display time can be controlled according to predetermined rules. Thereby, the advertisement effect can be enhanced.

For example, the advertisement information management section 10 displays different advertisement information items in a time-division manner on the respective display sections 2 of wall display 1. Thus, a high advertisement effect can be obtained even if the display area is unchanged. This advantage cannot be achieved if paper pamphlets are displayed on shelves, and it is one of merits of electronically produced advertisement information.

The display method can be changed according to the attributes of commodities. For example, display positions may be controlled such that advertisement information is displayed at a level suitable for the target commodity customer class in accordance with an average height associated with the age and sex. The advertisement information management section 10 may display different advertisement information in accordance with a time zone in which customers of an associated customer class pass by the place of the wall display 1.

For example, advertisement information directed to the aged and housewives may be displayed during the day. In the evening, advertisement information directed to office girls and students may be displayed. In this way, advertisement information to be displayed can be managed in accordance with time slots.

It is also possible to change the display position (display sections 2 used for display) of advertisement information in accordance with customers' print requests for advertisement, which can be understood from customer use histories (number of prints) of the plan commodity management system according to the present invention.

For example, as regards the advertisement information in the advertisement history DB 12 as shown in FIG. 6, the advertisement history ID “001” is associated with advertisement ID “001” which was displayed on the display section 2 at display position “A3” and it is understood that the number of print requests for this advertisement was 0. On the other hand, the advertisement history ID “002” is associated with advertisement ID “002” which was displayed on the display section 2 at display position “C4” and it is understood that the number of print requests for this advertisement was 5. Based on this data, the advertisement ID “001” was displayed on the display section 2 at display position C4 and the advertisement ID “002” was displayed on the display section at position A3. As a result, as the advertisement history ID “003” indicates, three print requests were issued for the advertisement ID “001” and four print requests were issued for the advertisement ID “001”. The total number of prints associated with the advertisement Ids “001” and “002” increased. The total effect of advertisement can be enhanced by adjusting the display positions (display sections 2 used for display).

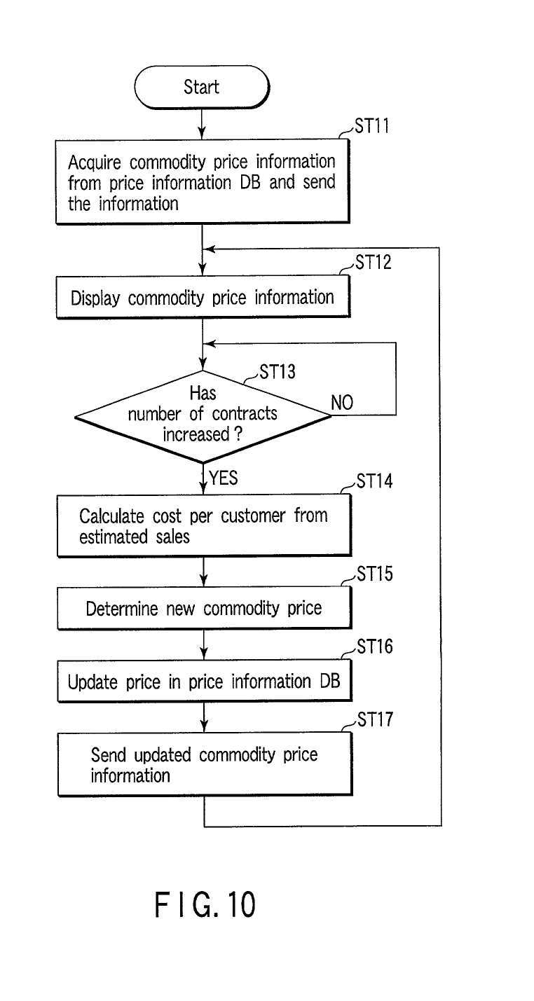

Referring to a flow chart of FIG. 10, a description will now be given of a price changing process for plan commodities in the plan commodity management system.

The plan commodity management system of this invention can handle plan commodities whose prices are variable in accordance with a variation in commodity information. For example, this system can adopt a price system in which the price of a plan commodity is lowered in accordance with an increase in number of applications (number of contracts) for the plan commodity.

To start with, the controller 20 controls the commodity information management section 7 to acquire current commodity price information from the price information DB 9, and sends the acquired information to the display control section 13 (ST11). Based on the commodity price information, the display control section 13 displays the commodity price on the display section 2 (ST12).

If a new application for the commodity has been accepted and the number of contracts has increased, the cost per person of the plan commodity decreases due to a volume effect and the price per person can be lowered if the profit amount is unchanged.

Thus, if the number of contracts has increased (ST13), the controller 20 calculates a new commodity price by controlling the commodity information management section 7 (ST14) and determines a new commodity price (ST15). The controller 20 then controls the commodity information management section 7 to update the commodity price in the price information DB 9 (ST16), and sends the updated commodity price information to the display control section 13 (ST17).

The control returns to step ST12 and the display control section 13 displays the updated commodity price on the display section 2 on the basis of the updated commodity price information.

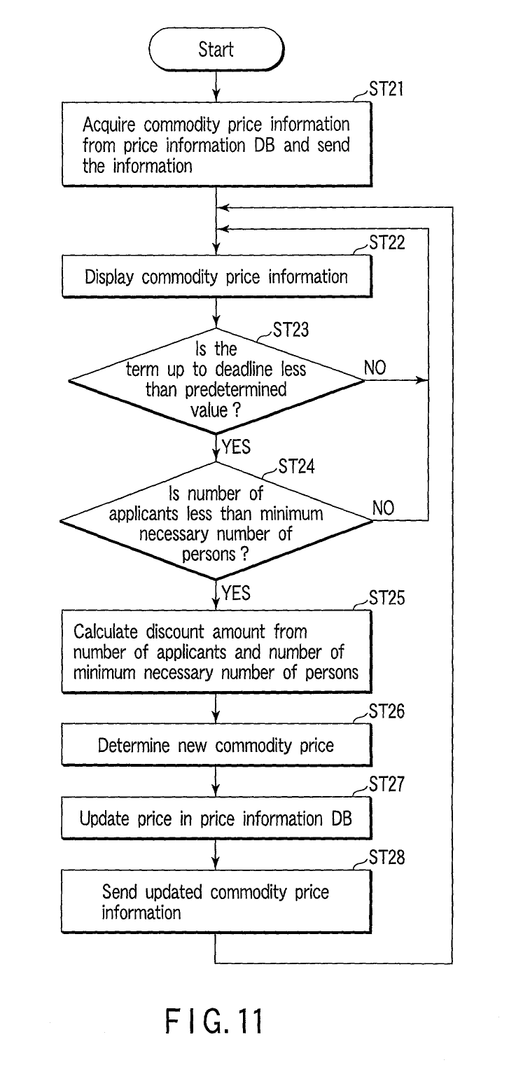

Referring to a flow chart of FIG. 11, a description will now be given of a price changing process for plan commodities in accordance with the number of customer applications and the minimum necessary number of persons.

The plan commodity management system of this invention can adopt a price system in which the price of a plan commodity is varied in accordance with the number of customer applications and the minimum necessary number of persons.

To start with, the controller 20 controls the commodity information management section 7 to acquire current commodity price information from the price information DB 9, and sends the acquired information to the display control section 13 (ST21). Based on the commodity price information, the display control section 13 displays the commodity price on the display section 2 (ST22).

The controller 20 controls the commodity information management section 7 to refer to the price information DB 9 and to determine whether the present time point is in the discount term immediately before the deadline, on the basis of the deadline date and the discount term just before the deadline which are set for the commodity in advance (ST23). If the present time point is in the discount term immediately before the deadline, the controller 20 controls the commodity information management section 7 to refer to the commodity information DB 8 and to compare the current number of applicants with the minimum necessary number of persons (ST24). If the current number of applicants is greater than the minimum necessary number of persons (i.e. if it has already been determined to carry out the plan commodity), the controller 20 determines that no discount is made.

If the current number of applicants is less than the minimum necessary number of persons, the controller 20 calculates a discount amount on the basis of the number of applicants and the minimum necessary number of persons (ST25) and determines a new commodity price (ST26). The controller 20 then controls the commodity information management section 7 to update the commodity price in the price information DB 9 (ST27), and sends the updated commodity price information to the display control section 13 (ST28).

The control returns to step ST22 and the display control section 13 displays the updated commodity price on the display section 2 on the basis of the updated commodity price information.

For example, in the price information DB 9 shown in FIG. 4, the discount term just before the deadline is set to be “10 days” for the commodity ID “002”. Thus, when the number of remaining days up to the deadline of the commodity (Aug. 16, 2000) has become 10 (Aug. 7, 2000), the controller 20 controls the commodity information management section 7 to refer to the commodity information associated with the commodity ID “002” in the commodity information DB 8.

In the commodity information DB 8, the minimum necessary number of persons for the commodity ID “002” is “5”, while the number of applicants is “3”. Thus, this commodity cannot be carried out in the current state. If the commodity cannot be performed, the customers' needs could not be satisfied, and no profit could not be gained from the plan commodity. It is thus required to increase the number of applicants in order to perform the plan commodity.

In the plan commodity management system of the present invention, the controller 20 controls the commodity information management section 7 to lower the commodity price in accordance with the discount amount set in the price information DB 9, and to display the lowered price as advertisement information and prompt participation by customers.

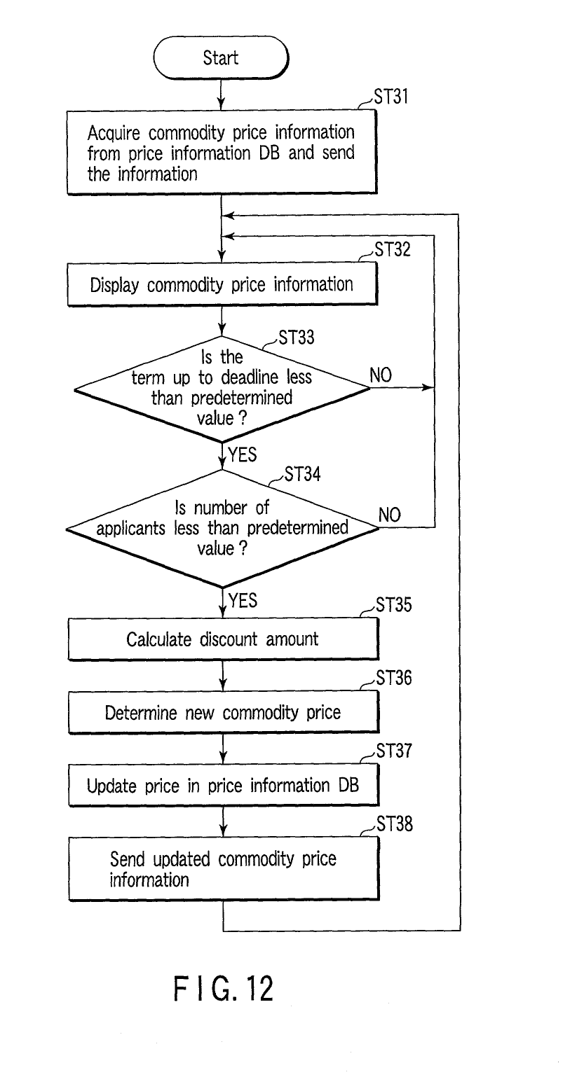

Referring to a flow chart of FIG. 12, a description will now be given of a price changing process for plan commodities in accordance with the number of customer applications and the condition of the term up to the deadline of application.

The plan commodity management system of this invention can adopt a price system in which the price of a plan commodity is varied in accordance with the number of customer applications and the condition of the term up to the deadline of application.

To start with, the controller 20 controls the commodity information management section 7 to acquire current commodity price information from the price information DB 9, and sends the acquired information to the display control section 13 (ST31). Based on the commodity price information, the display control section 13 displays the commodity price on the display section 2 (ST32).

The controller 20 controls the commodity information management section 7 to refer to the price information DB 9 and to determine whether the present time point is in the discount term immediately before the deadline, on the basis of the deadline date and the discount term just before the deadline which are set for the commodity in advance (ST33). If the present time point is in the discount term immediately before the deadline, the controller 20 controls the commodity information management section 7 to refer to the commodity information DB 8 and to compare the current number of applicants with the reference number of persons who possibly apply for the commodity (ST34). If the current number of applicants is greater than the reference number of persons, the controller 20 determines that no discount is made.

If the current number of applicants is less than the reference number of persons, the controller 20 controls the commodity information management section 7 to calculate a discount amount set in the price information DB 9 (ST35) and determines a new commodity price (ST36). The controller 20 then controls the commodity information management section 7 to update the commodity price in the price information DB 9 (ST37), and sends the updated commodity price information to the display control section 13 (ST38).

The control returns to step ST32 and the display control section 13 displays the updated commodity price on the display section 2 on the basis of the updated commodity price information.

For example, in the price information DB 9 shown in FIG. 4, the discount term just before the deadline is set to be “14 days” for the commodity ID “003”. Thus, when the number of remaining days up to the deadline of the commodity has become 14, the controller 20 controls the commodity information management section 7 to refer to the commodity information associated with the commodity ID “003”, in the commodity information DB 8.

In the commodity information DB 8, the reference number of persons for the commodity ID “003”, is “15”, while the number of applicants is “5”. Thus, the controller 20 controls the commodity information management section 7 to lower the commodity price in accordance with the discount amount set in the price information DB 9, and to display the lowered price as advertisement information. It is thus possible to prompt participation by customers.

A process for a novel mode plan commodity will now be described.

According to the plan commodity management system of the present invention, the feasibility of performance of a plan commodity can be determined on the basis of an upper limit price proposed by a customer, by virtue of the combination of the feature that the commodity price can be varied and the feature that the customer-participation-type/event-performance-type plan commodity can be handled. Thereby, a new-mode plan commodity, for which a customer can apply with his/her proposed price, can be handled.

For example, the feasibility of performance of a plan commodity and the acceptability/non-acceptability for customer's participation can be determined on the basis of comparison between a minimum price for performing a commodity, which can be calculated from the relationship between the content of the plan commodity and the number of participants, and an upper limit price proposed by each customer.

In this description, price information of the commodity ID “003” in the price information DB 9 is taken up by way of example. As regards the commodity ID “003”, the cost per person is “40000” yen, the common cost required in carrying out the commodity irrespective of the number of participants is “120000” yen, and the profit rate indicative of the ratio of profit added to the cost in determining the fee for participation in the plan of the commodity is “50%”. Specifically, in the case of the profit rate of “50%”, if the number of participants is one, the profit is 80,000 yen. If the number of participants is two, the profit is 100,000 yen. If the number of participants is three, the profit is 120,000 yen. If the number of participants is four, the profit is 140,000 yen. If the number of participants is five, the profit is 160,000 yen.

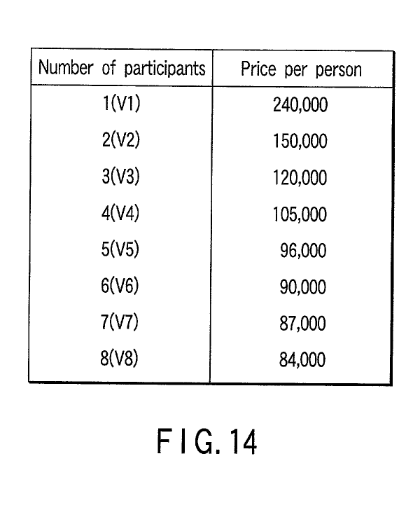

If the price per person according to the number of participants in the commodity is calculated based the above data, variable prices as shown in FIG. 14 are approximately obtained. Specifically, in order to carry out the commodity ID “003” with two participants, the price per person has to be 150,000 yen. In order to carry out the commodity ID “003” with three participants, the price per person has to be 120,000 yen. When the commodity ID “003” is carried out with eight participants, however, the price per person may be only 84,000 yen.

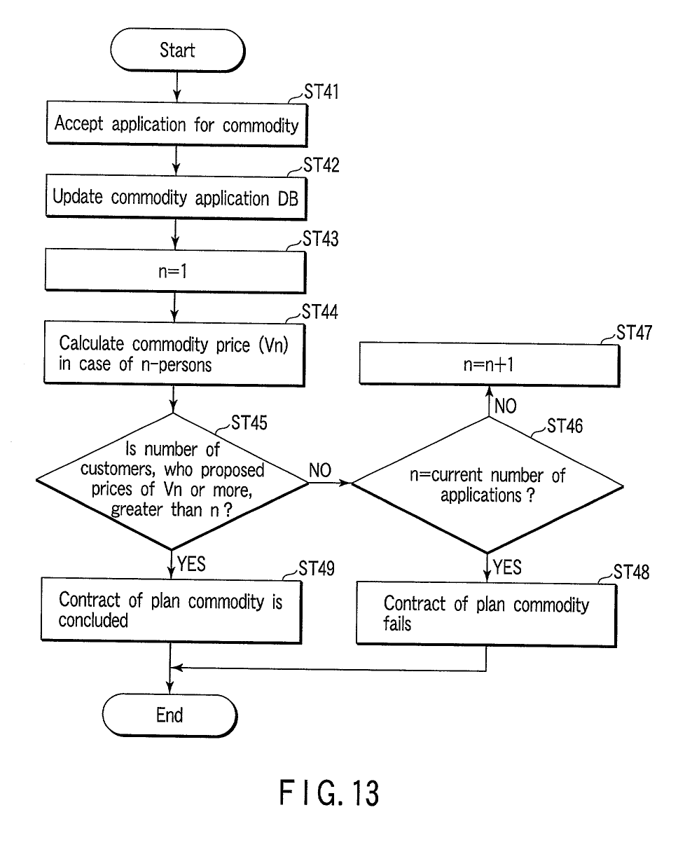

Taking up the commodity ID “003” by way of example, an operation in the case where applications for the plan commodity have been accepted will now be described with reference to a flow chart of FIG. 13.

A description will first be given of a process at the time an application with application ID “06” (i.e. six participants) in the commodity application DB 19 shown in FIG. 7 has been accepted. When an application for the commodity has been accepted (ST41), the controller 20 controls the commodity information management section 7 to assign an application ID to the application, and updates the commodity application DB 19 on the basis of the commodity ID and a highest affordable price proposed by the participant (the customer's proposed price) (ST42). The controller 20 calculates a commodity price V1 at the time of one participant (n=1) (ST43, 44). As is shown in the examples of variable prices in FIG. 14, when the number of participants for the commodity is one (V1), the calculated price is 240000 yen.

The controller 20 controls the commodity information management section 7 to refer to the commodity application DB 19, and confirms whether there is one or more customers who proposed prices of V1 or more (ST45). In the example of the commodity application DB 19, there is no customer who proposed the price of 240000 yen or more. Thus, the controller 20 calculates a commodity price V2 at the time of two participants (n=2), assuming that there are two participants (ST46, 47, 44). The price of 150000 yen is calculated at the time of two participants (V2) for the commodity. In the example of the commodity application DB 19, there is no customer who proposed the price of 150000 yen or more. Assume that the controller 20 has repeated the calculation of the commodity price up to five participants (n=5) in steps ST46, 47, 44 and 45.

When the number of participants is six (n=6), as shown in the examples of variable prices in FIG. 14, the price per person is 90000 yen. On the other hand, in FIG. 7, five of six persons with application IDs “01” to “06” proposed prices of 90000 yen or more, and this number fails to reach six. Since the present calculation is made based on the current number of applicants (six) and the case of six participants (n=6) (ST46), the contract of the plan commodity fails to be concluded at the time the application with application ID “06” is accepted.

Subsequently, when the application with application ID “07” is accepted (ST41, 42), the same process as above is carried out up to five participants (ST43, 44-47). In the case of six participants, the price per person is 90000 yen as mentioned above. On the other hand, in FIG. 7, six of seven persons with application IDs “01” to “07”, except the person with application ID “02”, proposed prices of 90000 yen or more (ST45). Thus, at this time point, the contract of the plan commodity is concluded (ST49). Specifically, since six persons with application IDS “01”, “03”, “04”, “05”, “06” and “07” proposed prices of 90000 yen or more, the contract of this plan commodity can be concluded with the price of 90000 yen per person.

At the time the application with application ID “07” has been accepted in FIG. 7, if the number of participants is set at seven, the price per person is 87000 yen, as shown in the examples of variable prices in FIG. 14. Thus, the customer with application ID “02”, who proposed the highest affordable price of 85000 yen, is unable to participate in the plan commodity. However, when an application with application ID “08” has been accepted, the price per person is 84000 yen, as shown in the examples of variable prices in FIG. 14. Thus, the customer with application ID “02”, can participate, and all of the eight applicants including the customer with application ID “02” can participate in the plan commodity.

With the above process, a new-mode plan commodity, which is carried out based on customers' proposed prices, can be handled, and various customer needs can be satisfied.

Besides, a commodity with a characteristic price system can be provided as a customer-participation-type commodity, which is different from a reverse-auction system for general goods.

Generation of plan commodities will now be described.

According to the plan commodity management system of the present invention, it is possible to generate a new plan commodity meeting a customer's request. In addition, a plan commodity generated according to a customer's request may be advertised like ordinary plan commodities, and applications for participation may be accepted. According to the number of applications for participation, the feasibility of performance of the plan commodity may be determined. Thereby, a variety of customer needs may be met, and the planning cost may be reduced since customers conduct planning works.

Moreover, according to the plan commodity management system of the present invention, a generated plan commodity can be quickly advertised at low cost. The feasibility of performing the plan commodity can finally be determined on the basis of the number of applicants for participation as a result of advertisement. Thereby, the risk of loss in carrying out plan commodities can be reduced.

Various kinds of information are used for generation of commodities, as shown in FIG. 8. There is a prior-art system for proposing a custom plan in which an accommodation place, transportation, etc. are combined according to customer requests. However, the plan proposed in this system is a plan specifically produced for the customer who requested it. It is not assumed that other participants are accepted by advertisement.

According to the plan commodity management system of this invention, a new plan commodity generated by a customer can be generally advertised. When a plan commodity is generated, the commodity generating section 5 rationally determines the feasibility of performing the plan commodity, on the basis of not only simple combinations of elements, but also considerations as to whether the plan commodity can be carried out without contradiction, whether there is no legal problems, whether there is no problem with weather, geography, etc.

As has been described above, according to the embodiments of the invention, electronically produced advertisement information on plan commodities can be displayed without losing merits of conventional paper-pamphlet display systems, and customers can obtain pamphlets as in the prior art.

The advertisement effect can be enhanced by performing the advertisement information display control.

Plan commodities whose prices are variable can be handled.

A new-mode plan commodity, which is carried out based on customers' proposed prices, can be handled.

A plan commodity based on a customer's proposal can be generated and advertised.

What is claimed is:

1. An advertisement information processing system for processing advertisement information relating to various commodities, comprising:
storage means for storing, in a mutually associated manner, display information and print information on the advertisement information relating to various commodities;
advertisement display means, composed of a plurality of display means, for displaying the display information stored in the storage means;
display control means for effecting a control to display one or more display information items stored in the storage means on said plurality of display means constituting the advertisement display means;
a plurality of instruction means, provided in association with the plural display means constituting the advertisement display means, for individually instructing printing of the display information displayed on the display means;
print control means for effecting, when printing is instructed by any one of the plural instruction means, a control to read out the print information and print out the print information, which corresponds to the display information displayed on the display means associated with the instruction means; and
print means for printing the print information controlled by the print control means.

2. An advertisement information providing system according to claim 1, wherein said advertisement display means is a display composed of a plurality of liquid crystal displays or CRT displays provided on a wall surface in an office.

3. An advertisement information providing system according to claim 1, wherein said display control means effects a control to display one or more display information items stored in the storage means on the plurality of display means constituting the advertisement display means according to preset rules.

4. An advertisement information providing system according to claim 1, wherein said display control means effects a control to display one or more display information items stored in the storage means on the plurality of display means constituting the advertisement display means in a time-division manner.

5. An advertisement information providing system according to claim 1, wherein said display control means effects a control to display the display information stored in the storage means by varying display rules, such as positions of the display means used for display, time slots, time lengths, and the number of times, in accordance with characteristics of the commodity.

6. An advertisement information providing system according to claim 1, wherein said display control means effects a control to display the display information stored in the storage means by varying display rules, such as positions of the display means used for display, time slots, time lengths, and the number of times, in accordance with a print history controlled by the print control means.

7. An advertisement information providing system according to claim 1, wherein said print means is a printer.

8. An advertisement information processing system for processing commodity information and advertisement information relating to plan commodities planned in advance, comprising:
storage means for storing commodity information relating to the plan commodities, and display information and print information serving as advertisement information relating to the plan commodities;
advertisement display means, composed of a plurality of display means, for displaying the display information serving as the advertisement information;
price control means for effecting a control to vary the price of the plan commodity in accordance with a variation in the commodity information stored in the storage means; and
display control means for effecting a control to display price information controlled by the price control means and the display information that is stored in the storage means and serves as the advertisement information on the plan commodity on one or more of the display means constituting the advertisement display means.

9. An advertisement information providing system according to claim 8, wherein the display control means effects a control to display in real time the price information controlled by the price control means.

10. An advertisement information providing system according to claim 8, wherein the price control means varies the price of the plan commodity in according with an increase/decrease in the number of applications for the plan commodity.

11. An advertisement information providing system according to claim 8, wherein the price control means varies the price of the plan commodity in according with the number of applications for the plan commodity and a minimum necessary number for carrying out the plan commodity.

12. An advertisement information providing system according to claim 8, wherein the price control means varies the price of the plan commodity in according with the number of applications for the plan commodity and the number of days up to a deadline of applications.

13. An advertisement information processing system for processing commodity information and advertisement information relating to plan commodities planned in advance, comprising:
acceptance means for accepting customer applications for the plan commodity and customers' proposed upper limit prices;
storage means for storing application information and proposed upper limit price information relating the plan commodity accepted by the acceptance means; and
determination means for determining whether the plan commodity is feasible or not, on the basis of the application information and proposed upper limit price information stored in the storage means.

14. An advertisement information providing system according to claim 13, wherein the determination means determines whether the plan commodity is feasible or not by comparing a minimum price for carrying out the plan commodity, which is calculated from the content of the plan commodity and the number of applications, and upper limit prices that are proposed by all of customers for the plan commodity and stored in the storage means, and when the plan commodity is not feasible, the determination means determines the acceptability/non-acceptability for each customer's participation on the basis of all customers' proposed upper limit prices for the plan commodity.

15. An advertisement information processing system for processing commodity information and advertisement information relating to commodities, comprising:
acceptance means for accepting a customer's request for the commodity;
generating means for generating a plan commodity according the request accepted by the acceptance means;
storage means for storing commodity information relating to the plan commodity generated by the generating means, and display information and print information serving as advertisement information relating to the plan commodity;
advertisement display means, composed of a plurality of display means, for displaying the display information serving as the advertisement information; and
control means for effecting a control to display the display information serving as the advertisement information relating to the plan commodity on the advertisement display means on the basis of the commodity information relating to the plan commodity that is stored in the storage means.

16. An advertisement information providing system according to claim 15, wherein the control means includes determination means for determining whether the plan commodity generated by the generating means is feasible or not, and display control means for controlling display on the advertisement display means in accordance with a determination result of the determination means.
